(19) United States
(12) Patent Application Publication
(10) Pub. No.: US 2015/0298995 A1
(43) Pub. Date: Oct. 22, 2015

(54) FILTER AND METHOD OF ULTRAFILTRATION

(71) Applicant: BWT AG, Mondsee (AT)

(72) Inventors: Juergen Johann, Nussloch (DE); Monique Bissen, Mondsee (AT); Bernd Bauer, Vaihingen an der Enz (DE)

(21) Appl. No.: 14/408,701

(22) PCT Filed: Jun. 28, 2013
(86) PCT No.: PCT/EP2013/063636

§ 371 Date: Dec. 17, 2014

(30) Foreign Application Priority Data
Jun. 28, 2012 (DE) 10 2012 105 720.6
Sep. 28, 2012 (DE) 10 2012 109 267.2

(51) Int. Cl. C02F 1/44; B01D 61/14; B01D 61/18

(52) U.S. Cl. CPC C02F 1/444; B01D 61/18; B01D 61/145; C02F 2307/04

(57) ABSTRACT

A filter for ultrafiltration, which filter comprises a membrane pack having partially hydrophobic membranes.

### FIELD OF THE INVENTION

The invention relates to a method and a filter for ultrafiltration. In particular, the invention relates to a filter for water treatment, which includes outgassing filter media such as activated carbon or ion exchangers, which produce carbonic acid and therefore also undissolved carbon dioxide through the exchange of hydrogen ions with hydrogen carbonate ions of drinking water. The invention relates to both gravity-operated and pressure-operated water filters.

### BACKGROUND OF THE INVENTION

Devices and methods for ultrafiltration are well known. For this purpose, in particular membranes are used to separate particles, in particular of a particle size from 0.01 to 0.001 microns. Such devices are mainly used in pharmacy and medicine.

It is also known that filters for ultrafiltration allow to sterilize liquids, since bacteria normally cannot pass through such a filter. For this purpose, sterile ultrafilters are used. In particular, capillary membranes are known as a filter medium for ultrafiltration, in which the wall of the capillary constitutes the membrane.

Filters for ultrafiltration are therefore in principle also suitable for sterilization or disinfection of drinking water. However, it has been found that the employed drinking water often contains gases, for example carbonic acid or carbon dioxide, or even air, as a result of outgassing media which cause bubble formation in and blocking of the filter.

Basically, filters for ultrafiltration are impermeable to gas bubbles.

Rather, it is established practice that gas bubbles are used to check a filter for ultrafiltration for its functionality. In a so-called bubble-point test it is checked whether the filter medium is permeable to gas. When bubbles pass through the filter, it can be concluded that the membrane is damaged and the filter is therefore no longer functional.

This leads to the problem that prior art filters for ultrafiltration are only of limited use for applications in which the water to be sterilized passes through the filter by its own gravity. In particular in water filters comprising activated carbon or ion exchangers as the filter media, which exchange hydrogen ions for alkali or alkaline earth ions, blocking of the ultrafilter occurs due to gas formation.

Generally, prior art filters for ultrafiltration are not suitable for water that includes added carbonic acid.

Known gravity-operated household water filters normally comprise an ion-exchange resin. It is also known to add activated carbon to the filter medium. It is further known to use a nonwoven fabric for removing suspended particles. However, these approaches do not permit to reliably remove bacteria from the drinking water.

Pressure-operated water filters for the treatment of hot drinks usually contain ion exchangers which exchange hydrogen ions, and activated carbon. Because of the outgassing activated carbon and the carbonic acid or carbon dioxide produced during the ion exchange, prior art ultrafilters cannot be used downstream water filters, since the ultrafilters would be blocked due to the gases.

Further, chemical substances with a disinfecting effect can be added to the filter material. However, this may have adverse impacts on the water. In addition, in a gravity-operated filter the disinfectant is usually not continuously released, so that a sufficient effect is not always guaranteed throughout the entire lifetime of the filter material.

Furthermore, it is known that water dispensers having a storage tank, which are often designed to dispense cooled and/or non-cooled water, involve a risk of microbial multiplication in the water. To counteract this, it is known from practice to heat the water in the storage container so as to kill microbes. For example, this may be done periodically by heating the entire water container. This procedure is time-consuming and energy-intensive.

Further, microbes may develop in particular even in the vicinity of the outlet of the water dispenser, which will naturally not be reached by the heated water, but flushed out when actuating the water dispenser.

### OBJECT OF THE INVENTION

In view of the above, the invention is based on the object to provide a device and a method for ultrafiltration, in which the risk of filter blocking by gas bubbles is at least mitigated.

More particularly, an object of the invention is to provide a device for ultrafiltration which may even be used in conjunction with a gravity-operated filter.

### SUMMARY OF THE INVENTION

The object of the invention is already achieved by a method for ultrafiltration and by a filter for ultrafiltration according to the illustrative embodiment of the present invention.

Furthermore, the invention relates to a water dispenser and to a gravity-operated household water filter.

The invention relates to a filter for ultrafiltration, i.e. a filter by means of which in particular bacteria but also suspended particles with a size of less than 1 micron, in particular less than 0.1 microns can be separated.

The filter for ultrafiltration comprises a membrane pack which according to the invention partially comprises hydrophobic membranes.

Hydrophobic membranes refer to membranes whose surface is not wetted by water, at least partially, under normal conditions of use of the filter.

In particular a surface is used, which has a contact angle to water of more than 90°, preferably more than 110°, and most preferably more than 120°.

For example, a polyhalogen olefin, in particular polytetrafluoroethylene (PTFE) may be used as the hydrophobic material.

The remaining membranes of the membrane pack, i.e. the membranes which are not hydrophobic in the sense of the invention, are wetted by water under normal conditions of use.

In particular a material is used, which has a contact angle to water of less than 80°, preferably less than 75°.

For example, a polyethersulfone may be used for these membranes. It is also possible to use polyacrylonitrile or cellulose triacetate.

Compared to polyethersulfone, the two latter materials have a smaller contact angle to water. However, the use of membranes made from polyethersulfone already allows to provide a filter for ultrafiltration which is generally also suitable for gravity operation.

The invention is based on the finding that the hydrophobic membranes are not wetted by the medium to be filtered, but that gas bubbles can rise in or along the hydrophobic membranes to leave the filter. Therefore the filter for ultrafiltration of the invention is not blocked by gas bubbles. It will be understood that such a filter would not be suitable for a bubble-point test because the filter is permeable even for rather large gas bubbles.

Surprisingly, it has been found that even a relatively small amount of hydrophobic material is sufficient to avoid blocking of the filter by gas bubbles.

In particular, the membrane pack comprises less than 50%, preferably less than 25%, and more preferably less than 10% of hydrophobic membranes, the percentage referring to the number of membranes.

In a preferred embodiment of the invention, the membranes of the membrane pack are provided in form of capillary membranes. In such capillary membranes, the walls of the capillary membranes provide a large surface through which the medium to be filtered can pass the filter. Preferably, the open end of the membranes defines the permeate side, i.e. in particular it is contemplated that the membranes are arranged in a sleeve and are bent, so that the open ends of the membranes form the outlet of the filter.

The water to be filtered therefore flows from the outside into the membranes and flows out via the open end of the capillary membranes. Gas, by contrast, can rise upwards along the hydrophobic capillary membranes which do not fill with liquid during operation, and can leave the filter.

The capillary membranes are preferably provided as a bundle in which the capillary membranes at least partially lie adjacent to each other.

The fibers may be disordered or may be compressed in such a way that at least in sections a hexagonal closest packing is formed.

Preferably, the bundle is folded and the ends of the capillary membranes are arranged on the permeate side. Rising gas escapes through the pores of the hydrophobic membranes at the folded end.

Preferably, the capillary membranes have an average pore size from 0.005 to 0.1 microns, preferably from 0.01 to 0.5 microns, and more preferably from 0.015 to 0.025 microns. The capillary membranes preferably have an average diameter (outer diameter) between 0.5 and 2 mm.

Furthermore, the invention relates to a method for ultrafiltration of fluids, in particular drinking water, wherein the liquid passes through a membrane pack comprising capillary membranes which are partially hydrophobic, so that gas present in the liquid is at least partially discharged through the hydrophobic capillary membranes. In particular a filter for ultrafiltration as described above is used.

The method of the invention is in particular also suitable for gravity operation.

Furthermore, the invention relates to a gravity-operated household water filter. The latter comprises a filter for ultrafiltration, in particular a filter for ultrafiltration as described above.

The gravity-operated household water filter usually comprises a filter medium which includes an ion-exchange material. In particular an ion-exchange resin is used. Usually, such gravity-operated household water filters are especially used to soften the water. At the same time, contaminants, especially heavy metals, can be removed, depending on the embodiment.

However, by additionally providing a filter for ultrafiltration, it is possible to remove bacteria from the water to be treated almost completely and in a very simple manner, even without the use of chemicals.

In particular, it is suggested that the filter for ultrafiltration is arranged below the ion exchanger.

Preferably, the filter for ultrafiltration is separable from another part of the household water filter, in particular from a filter cartridge including an ion-exchange resin.

Thus, in particular when replacing the ion-exchange material, the filter for ultrafiltration which normally has a longer lifetime may be separated and reused.

In a modification of the invention, the filter for ultrafiltration comprises a biocidal contact material on the permeate side, i.e. at the outlet. A biocidal contact material refers to a material which has a bactericidal and/or fungicidal effect when being contacted with water.

In particular silver, for example provided in form of a silver mesh, is considered. A biocidal material at the outlet prevents the formation of germs, algae, or fungi after the elimination of microbes by the membrane pack. In particular, the connection of a silver mesh which forms the final layer of the filter on the permeate side achieves the desired biocidal properties in a simple manner.

Furthermore, the invention relates to a water dispenser. The water dispenser usually comprises a water storage container and an actuating means for dispensing drinking water which may for example be dispensed even as sweetened cold drink.

Additionally, the water dispenser may comprise a means for cooling the water to be dispensed.

Furthermore, the water dispenser usually comprises a pedestal so that it can be positioned in particular in the commercial sector, so that customers may draw water.

According to the invention, the water filter comprises a filter for ultrafiltration which is preferably provided in form of an outlet of the water dispenser.

The present invention permits to prevent a release of bacteria which might develop in the storage container or the adjacent conduits.

If the filter is designed as an outlet, the water flows directly from the filter into the container of the user. By using the water filter as the final component in the water path, it is ensured that even microbes which develop at or in the outlet will not be dispensed.

In a modification of the invention, the outlet is surrounded by a touch guard. In particular a wall is provided which extends from the top at least to the level of the outlet, so that the outlet is protected from accidentally being touched.

This prevents the formation of germs on the only surface which is provided on the permeate side.

In a modification of the invention, the water dispenser comprises a biocidal contact material at its outlet, in particular a biocidal contact material as described above in conjunction with the filter for ultrafiltration.

Preferably, the water dispenser comprises a filter as described above, i.e. a filter for ultrafiltration in which the membrane pack comprises hydrophobic membranes.

In this way, the water dispenser is capable to dispense carbonated water. In particular sparkling water is considered, i.e. water that has such a high content of carbonic acid that it bubbles when pressure is released.

In particular, the water has a content of carbonic acid of more than 50 mg/l, preferably more than 200 mg/l of carbon dioxide.

Furthermore, the invention relates to a filter cartridge for drinking water. In particular, this embodiment of the invention is provided in form of a pressure-operated filter cartridge which is used, for example, in the feed conduit of a device for preparing beverages, in particular a coffee machine. Such filter cartridges are commonly also referred to as filter candles, and typically comprise a housing which comprises an inlet and an outlet.

The housing is usually filled with an ion-exchange material, in particular a weakly acidic cation-exchange resin.

According to the invention, the filter cartridge comprises a filter for ultrafiltration, which is preferably arranged on the outlet side, that is directly before the outlet.

Such a filter for ultrafiltration permits to reliably remove germs.

The filter for ultrafiltration is preferably provided in form of a membrane pack, in particular with one or more of the features described above.

In particular a filter for ultrafiltration as described above is used, in which a membrane pack comprises hydrophobic membranes.

By using hydrophobic membranes, it is ensured that the filter cartridge is not blocked by gas bubbles. Such gas bubbles may exist in particular after connection of the water filter and may be so large that they are not dissolved during operation, but might possibly block the filter cartridge permanently.

### BRIEF DESCRIPTION OF THE DRAWINGS

FIG. 1 is a schematic view of a filter for ultrafiltration.

FIG. 2 schematically illustrates the front side of a filter for ultrafiltration.

FIG. 3 is a schematic view of a gravity-operated household water filter.

FIG. 4 is a schematic view of a water dispenser.

FIG. 5 and FIG. 6 show an alternative embodiment of a filter for ultrafiltration.

FIG. 7 shows a filter cartridge that comprises a filter for ultrafiltration.

### DETAILED DESCRIPTION

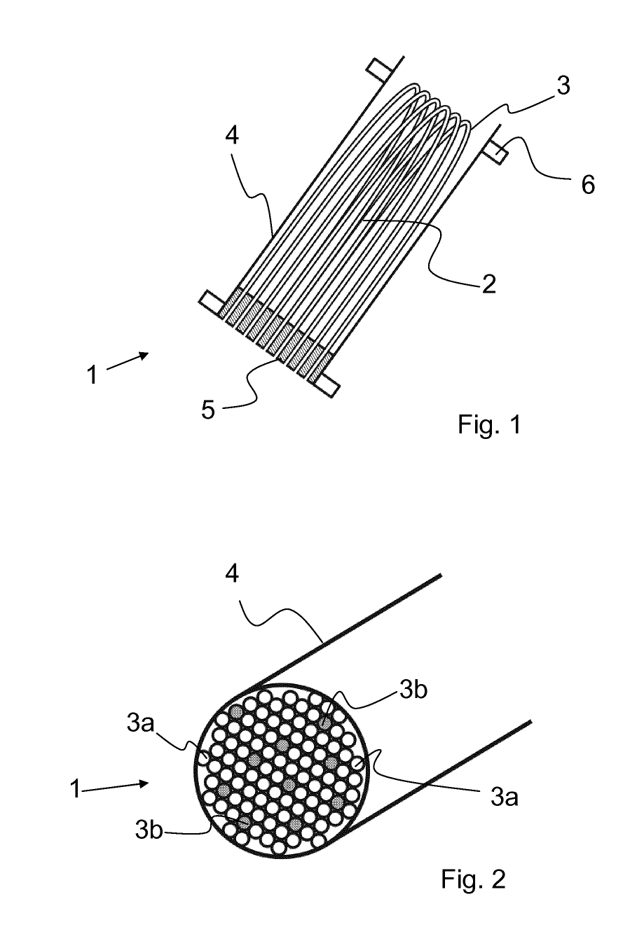

The invention will now be explained in more detail by way of schematically illustrated exemplary embodiments with reference to the drawings of FIG. 1 to FIG. 7.

FIG. 1 is a schematic view of a filter 1 for ultrafiltration.

Filter 1 for ultrafiltration comprises a membrane pack 2 which is arranged in a sleeve 4 preferably formed from plastics.

The membranes of membrane pack 2 are provided as a bundle made of capillary membranes 3, which bundle is folded once.

The membranes are bent within sleeve 4 and are embedded in a potting compound 5 on the permeate side. The open end of capillary membranes 3 therefore defines the outlet.

It will be understood that only a few capillary membranes are shown in this schematic view, and that filter 1 for ultrafiltration comprises a multitude of capillary membranes 3.

Sleeve 4 comprises fastening means 6 which may for example be provided in form of a bayonet mount or a thread.

FIG. 2 schematically illustrates the front side, i.e. the outlet, of filter 1 for ultrafiltration.

It can be seen that in this exemplary embodiment a part 3b of the capillary membranes is textured, for schematically illustrating the invention. Capillary membranes 3b are hydrophobic, whereas capillary membranes 3a are hydrophilic, so that they can absorb the water under normal conditions of use.

During operation, gas can now rise upwards through hydrophobic capillary membranes 3b.

The water to be filtered flows out through the open ends of capillary membranes 3a. Thus, the filter for ultrafiltration will not be blocked by gas bubbles.

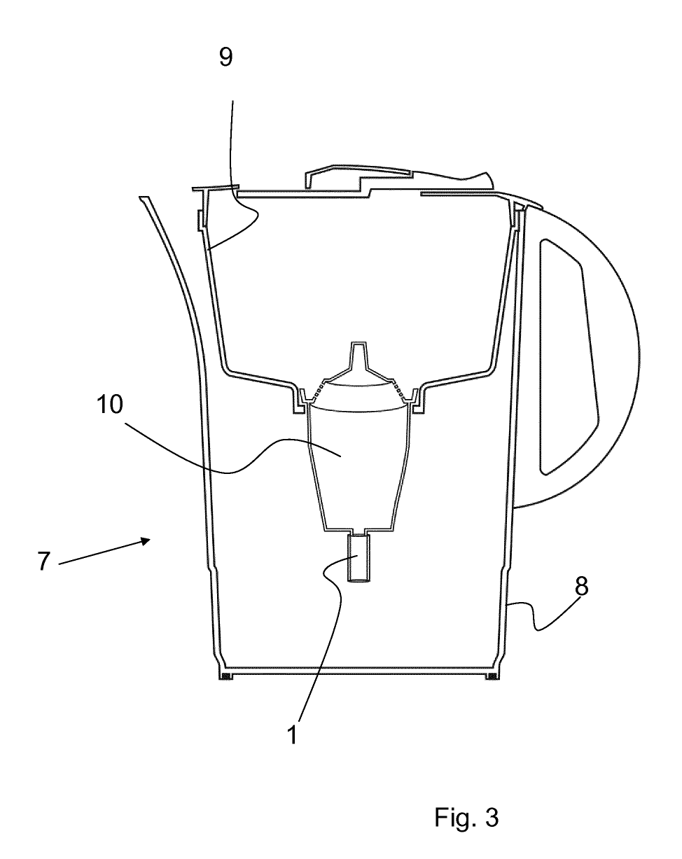

FIG. 3 is a schematic view of a gravity-operated household water filter 7.

Gravity-operated household water filter 7 comprises a jug 8 for receiving the filtered water.

Further, household water filter 7 comprises a funnel 9 into which the water to be treated is poured.

The water passes through a filter cartridge 10 which is filled with an ion-exchange material.

After having passed through filter cartridge 10, the water passes through a filter 1 for ultrafiltration which is removably connected to filter cartridge 10.

Filter 1 for ultrafiltration eliminates bacteria. When filter cartridge 2 needs to be replaced, the filter for ultrafiltration can be removed and reused.

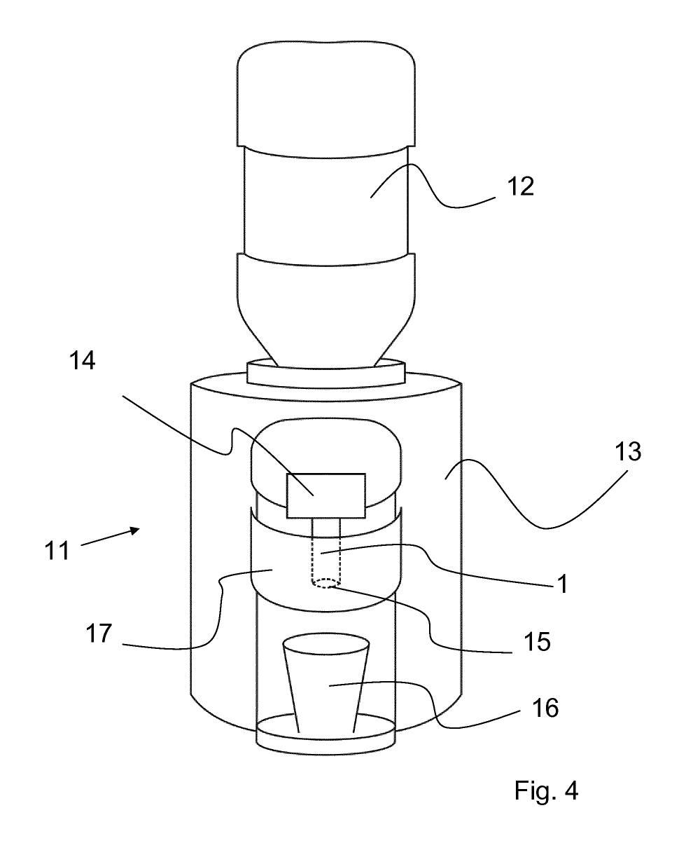

FIG. 4 is a schematic view of a water dispenser 11. Water dispenser 11 comprises a water container 12 which is inserted in a housing 13.

An actuating means 14 is arranged on the housing, which may be pressed by the user. Then water will flow through outlet 15 into a cup 16 of the user, which can be arranged on a supporting surface of housing 13.

Outlet 15 is provided in form of a filter 1 for ultrafiltration.

Therefore, the filtered water will directly be delivered from filter 1 for ultrafiltration.

A touch guard 17 in form of a surrounding wall is arranged in front of outlet 15 and prevents a user from accidentally touching outlet 15 and contaminating it with bacteria.

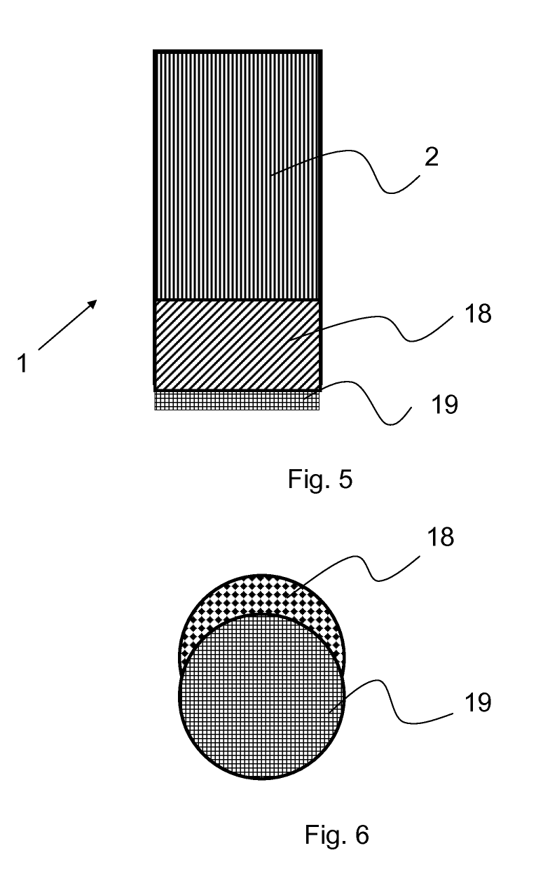

Referring to the drawings of FIG. 5 and FIG. 6, an alternative embodiment of a filter 1 for ultrafiltration will be explained in more detail, which can be used in particular for the water dispenser described above.

According to this alternative embodiment, filter 1 for ultrafiltration comprises a silver mesh 19 as biocidal contact material which is arranged on the permeate side downstream membrane pack 2.

Silver mesh 19 prevents the formation of microbes, algae, or fungi in the adhering water.

An intermediate layer 18 may be provided between silver mesh 19 and membrane pack 2, which intermediate layer is permeable to water and serves as a carrier for silver mesh 19.

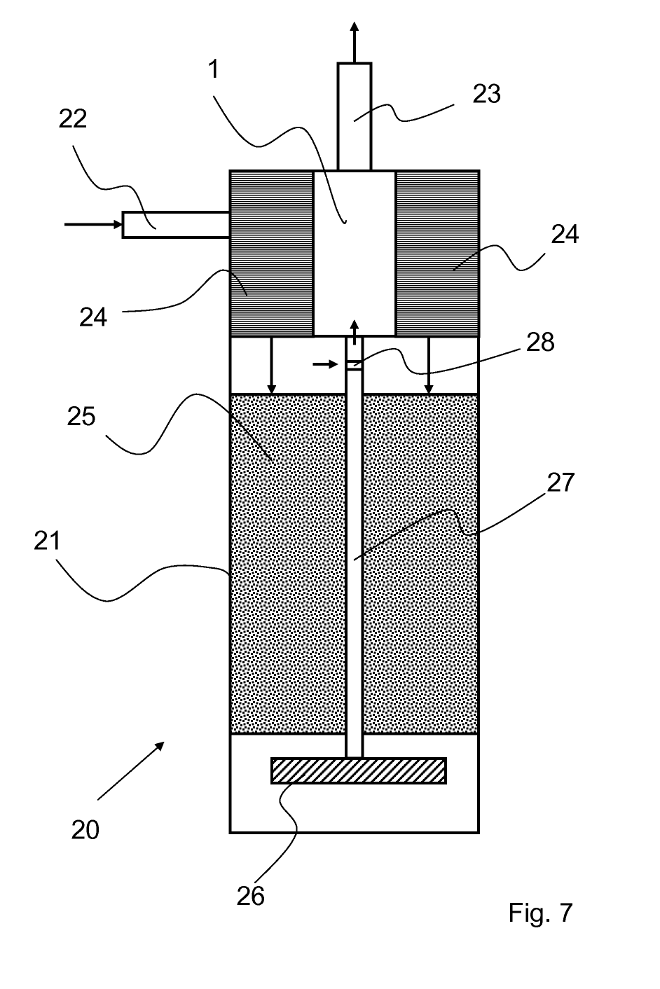

FIG. 7 shows a filter cartridge 20 which comprises a filter 1 for ultrafiltration.

Filter cartridge 20 is provided in form of a filter cartridge that is insertable into a feed conduit and comprises an inlet 22 and an outlet 23. The water to be treated flows through inlet 22 into housing 21 of filter cartridge 20 and leaves housing 21 through outlet 23.

The path of the water is indicated by arrows.

Such a filter cartridge 20 is commonly also referred to as a filter candle.

After having passed through inlet 22, the water to be treated first passes through a layer of activated carbon 24. Activated carbon 24 is intended for killing germs.

After leaving the layer of activated carbon 24, a part of the water to be treated passes through a layer of an ion-exchange material 25.

Then the water flow is reversed and the water flows through a fine filter 26 into a riser pipe 27 to be directed to outlet 23.

Above ion-exchange material 25, riser pipe 27 comprises a bypass 28 which may be provided, for example, in form of an opening in the riser pipe.

Bypass 28 allows part of the water to be treated to not pass through ion-exchange material 25 but to reach outlet 23 without an ion exchange to take place.

In this way the hardness of the water may be adjusted in a simple manner, by mixing softened water with non-softened water.

Downstream riser pipe 27, a filter 1 for ultrafiltration is arranged before outlet 23. The filter has a slightly larger diameter than riser pipe 27 and partially comprises hydrophobic membranes through which gas bubbles can escape which are present or may be produced due to gases dissolved in the water and/or after connection of filter cartridge 20.

The invention permits to provide a device for ultrafiltration of a simple configuration which ensures that the device is not blocked by gases dissolved in the water.

### LIST OF REFERENCE NUMERALS

1 Filter for ultrafiltration
2 Membrane pack
3 Capillary membrane
4 Sleeve
5 Potting compound
6 Fastening means
7 Household water filter
8 Jug
9 Funnel
10 Filter cartridge
11 Water dispenser
12 Water container
13 Housing
14 Actuating means
15 Outlet
16 Cup
17 Touch guard
18 Intermediate layer
19 Silver mesh

What is claimed is:

1. A filter for ultrafiltration, comprising a membrane pack wherein the membrane pack partially comprises hydrophobic membranes.

2. The filter for ultrafiltration as claimed in claim 1, wherein the membranes of the membrane pack are provided in form of capillary membranes.

3. The filter for ultrafiltration as claimed in claim 2, wherein the capillary membranes have a pore diameter from 0.01 to 0.5 microns.

4. The filter for ultrafiltration as claimed in claim 3, wherein the capillary membranes have a diameter between 0.5 and 2 mm.

5. The filter for ultrafiltration as claimed in claim 1, wherein the membrane pack has less than 25% of hydrophobic membranes.

6. The filter for ultrafiltration as claimed in claim 1, wherein the capillary membranes are provided as a bundle.

7. The filter for ultrafiltration as claimed in claim 6, wherein the bundle is folded.

8. The filter for ultrafiltration as claimed in claim 1, wherein the membrane pack is arranged in a sleeve.

9. The filter for ultrafiltration as claimed in claim 8, wherein the membranes of the membrane pack are bent on one side of the sleeve and terminate on the opposite side which defines the permeate side.

10. The filter for ultrafiltration as claimed in claim 1, wherein the hydrophobic membranes are made of a polyhalogen olefin.

11. The filter for ultrafiltration as claimed in claim 1, wherein the filter comprises a biocidal contact material on the permeate side.

12. A method for ultrafiltration of drinking water, wherein water passes through a membrane pack comprising capillary membranes which are partially hydrophobic, and wherein gas existing in the water is at least partially discharged through the hydrophobic capillary membranes.

13. The method for ultrafiltration as claimed in claim 12, wherein the liquid passes through the membrane pack by gravity.

14. A gravity-operated household water filter, comprising a filter for ultrafiltration as claimed in claim 1.

15. The gravity-operated household water filter as claimed in claim 14, wherein the filter for ultrafiltration is arranged below an ion exchanger.

16. The gravity-operated household water filter as claimed in claim 15, wherein the filter for ultrafiltration is provided in form of a sleeve which is removable from the ion exchanger.

17. A filter cartridge for drinking water, comprising an inlet and an outlet, and a filter for ultrafiltration as claimed in claim 1.

18. The filter cartridge for drinking water as claimed in claim 17, wherein the filter cartridge includes an ion-exchange material and the filter for ultrafiltration is arranged on the outlet side.

19. The filter cartridge for drinking water as claimed in claim 17, wherein the filter cartridge includes activated carbon and the filter for ultrafiltration is arranged on the outlet side.

20. A water dispenser, comprising a filter for ultrafiltration as claimed in claim 1.

21. The water dispenser as claimed in claim 20, wherein an outlet of the water dispenser is provided in form of a filter for ultrafiltration.

22. The water dispenser as claimed in claim 21, wherein the outlet is surrounded by a touch guard.

23. The water dispenser as claimed in claim 20, wherein the water dispenser contains carbonated water.

24. The water dispenser as claimed in claim 20, wherein the outlet comprises a biocidal contact material.

25. The water dispenser as claimed in claim 24, wherein the biocidal contact material is provided in form of a mesh at the outlet.

26. The water dispenser as claimed in claim 24, wherein the biocidal contact material comprises silver.
